(19) United States
(12) Patent Application Publication
(10) Pub. No.: US 2026/0137034 A1
(43) Pub. Date: May 21, 2026

(54) Tree and Shrub Identification Tag Device

(71) Applicant: Reed Andreas, Cannon Falls, MN (US)

(72) Inventor: Reed Andreas, Cannon Falls, MN (US)

(21) Appl. No.: 19/010,470

(22) Filed: Jan. 6, 2025

Related U.S. Application Data
(60) Provisional application No. 63/720,792, filed on Nov. 15, 2024.

(51) Int. Cl. A01G 9/00; G09F 3/02; G09F 3/04

(52) U.S. Cl. CPC A01G 9/006; G09F 3/02; G09F 3/04

(57) ABSTRACT

A tree and shrub identification tag device is provided. The device is comprised of a tag designed for efficient and adaptable plant identification while promoting environmental sustainability. The device comprises eco-friendly materials, including biodegradable and recyclable plastics, to ensure durability and weather resistance through UV protection additives and waterproof coatings. The tag body is available in various sizes and features a rubberized texture for enhanced grip. A notched slot at one end allows for secure attachment and easy removal, while perforations facilitate damage-free detachment from around a plant. The device may also be comprised of a color-coding system for categorizing plant types and includes a customizable surface for detailed labeling. Additionally, the tag may incorporate QR codes for accessing digital resources such as care guides and supplier information, enhancing overall plant management and user experience.

### CROSS-REFERENCE TO RELATED APPLICATION

The present application claims priority to, and the benefit of, U.S. Provisional Application No. 63/720,792, which was filed on Nov. 15, 2024, and is incorporated herein by reference in its entirety.

### FIELD OF THE INVENTION

The present invention relates generally to the field of identification tags. More specifically, the present invention relates to a tree and shrug identification tag device for identifying plants, wherein the device can be removed from a plant via a safe method that does not pose a risk of harming the plant. Accordingly, the present disclosure makes specific reference thereto. Nonetheless, it is to be appreciated that aspects of the present invention are also equally applicable to other like applications, devices, and methods of manufacture.

### BACKGROUND

Landscapers, gardeners, and plant nursery workers frequently rely on identification tags to distinguish between various species of trees and shrubs. These tags are critical for ensuring the proper care and handling of plants, as misidentification can lead to a range of costly mistakes. For instance, when plants are not correctly labeled, they may be subject to incorrect watering, fertilization, or pruning techniques, which can lead to plant damage, disease, or death. Standard identification tags, often made from rigid plastic or metal, can present a significant problem during their application and removal. These tags typically require manual force to attach or detach, increasing the likelihood of accidental damage to branches or foliage. Young or delicate branches are particularly vulnerable, as they can break when tags are tightly secured or improperly removed. Furthermore, when branches break, the overall health and appearance of the plant are compromised, which can reduce its market value or viability in a landscaping project.

Additionally, standard tags are not always customizable in terms of size or color, making it difficult to distinguish between different plant varieties in large nurseries or landscaping sites. This lack of versatility can lead to confusion, delays, and operational inefficiencies. In high-volume environments where many plants are tagged and processed daily, the inability to quickly identify or correctly categorize plants hampers productivity. Moreover, when workers are unable to remove tags easily, there is a higher chance that unidentified branches or plants will be accidentally cut or damaged during routine maintenance. This can lead to unnecessary waste and increased costs for plant replacement. Therefore, the absence of an easy-to-remove, customizable, and damage-free tagging solution poses a persistent problem for plant care professionals. Addressing these challenges requires an innovative approach to identification tags, one that prioritizes ease of use, adaptability, and the preservation of plant health.

Therefore, there exists a long-felt need in the art for the tree and shrub identification tag device that allows users to easily remove the tag without harming branches or shrubs. There also exists a long-felt need in the art for the tree and shrub identification tag device that accommodates various sizes and colors for different identification needs. Moreover, there exists a long-felt need in the art for the tree and shrub identification tag device that provides a simple and damage-free method of tagging plants in landscaping and nursery environments.

The subject matter disclosed and claimed herein, in one embodiment thereof, comprises a tree and shrub identification tag device. The device is comprised of a tag designed for efficient and adaptable plant identification while promoting environmental sustainability. The device comprises eco-friendly materials, including biodegradable and recyclable plastics, to ensure durability and weather resistance through UV protection additives and waterproof coatings. The tag body is available in various sizes and features a rubberized texture for enhanced grip. A notched slot at one end allows for secure attachment and easy removal, while perforations facilitate damage-free detachment from around a plant. The device may also be comprised of a color-coding system for categorizing plant types and includes a customizable surface for detailed labeling. Additionally, the tag may incorporate QR codes for accessing digital resources such as care guides and supplier information, enhancing overall plant management and user experience.

In this manner, the tree and shrub identification tag device of the present invention accomplishes all the foregoing objectives and provides a practical and efficient solution for identifying trees and shrubs while addressing the common problems associated with traditional tags. More specifically, the device has a perforated section that enables users to tear away the tag without causing harm to tree branches. The perforation ensures the tag can be detached easily, preventing branch breakage or damage. The availability of different colors and sizes allows users to adapt the tagging system to various plants and operational needs. This simple yet effective design improves the overall process of identifying and managing trees and shrubs in a way that is both convenient and protective of plant health.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a tree and shrub identification tag device. The tree and shrub identification tag device is designed to efficiently identify various types of plants, including trees, shrubs, flowers, and saplings while ensuring durability, adaptability, and environmental sustainability.

The device is comprised of eco-friendly materials capable of withstanding outdoor conditions, including biodegradable and recyclable plastics such as HDPE or PP. Weather resistance features are incorporated, such as UV stabilizers, antioxidants, or plasticizers to prevent fading and brittleness, along with a waterproof coating to maintain legibility in rain or humidity.

The device includes a tag body available in various sizes to accommodate different plant types. In some embodiments, the tag body features a rubberized texture for enhanced grip and durability. A first end of the tag body has a notched slot configuration designed for secure attachment and removal, even when wearing gloves. The notched slot, which may be keyhole-shaped or any other suitable shape, ensures the tag body remains securely looped around plant parts.

Each tag body features at least one line of perforations, positioned in the middle or at the second end, allowing for easy removal by tearing. Direction indicators, such as arrows, guide users on where to tear for clean removal, enabling the tag to unravel without cutting or damaging the plant.

A color-coding system enhances plant identification and care management. Different colors represent various plant categories, and UV-resistant pigments prevent fading from sun exposure. The tag body also includes a customizable surface for labeling plant species, care instructions, or planting dates, using permanent markers or adhesive labels.

Additional features include an embedded QR code that links to a digital location providing access to plant care guides, growth patterns, supplier information, or interactive databases. These digital features support efficient plant care and management.

Accordingly, the tree and shrub identification tag device of the present invention is particularly advantageous as it provides a practical and efficient solution for identifying trees and shrubs while addressing the common problems associated with traditional tags. More specifically, the device has a perforated section that enables users to tear away the tag without causing harm to tree branches. The perforation ensures the tag can be detached easily, preventing branch breakage or damage. The availability of different colors and sizes allows users to adapt the tagging system to various plants and operational needs. This simple yet effective design improves the overall process of identifying and managing trees and shrubs in a way that is both convenient and protective of plant health. In this manner, the tree and shrub identification tag device overcomes the limitations of existing plant identification tabs known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a tree and shrub identification tag device of the present invention while not attached around a piece of vegetation in accordance with the disclosed architecture;

FIG. 2 illustrates a perspective view of one potential embodiment of a tree and shrub identification tag device of the present invention while attached around a piece of vegetation in accordance with the disclosed architecture;

FIG. 3 illustrates a graphical view of components of a secondary digital location of one potential embodiment of a tree and shrub identification tag device of the present in accordance with the disclosed architecture; and

FIG. 4 illustrates a flowchart of a method of using one potential embodiment of a tree and shrub identification tag device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for the tree and shrub identification tag device that allows users to easily remove the tag without harming branches or shrubs. There also exists a long-felt need in the art for the tree and shrub identification tag device that accommodates various sizes and colors for different identification needs. Moreover, there exists a long-felt need in the art for the tree and shrub identification tag device that provides a simple and damage-free method of tagging plants in landscaping and nursery environments.

The present invention, in one exemplary embodiment, is comprised of a tree and shrub identification tag device. The device is designed to efficiently identify a range of plants, including trees, shrubs, flowers, and saplings while ensuring durability, adaptability, and environmental sustainability.

The device is comprised of eco-friendly materials capable of withstanding outdoor conditions, such as biodegradable and recyclable plastics like HDPE or PP. To prevent fading and brittleness, weather resistance features are incorporated, including UV stabilizers, antioxidants, or plasticizers, along with a waterproof coating to maintain legibility in wet conditions.

The device includes a tag body available in multiple sizes to accommodate different plant types. In some embodiments, the tag body features a rubberized texture to enhance grip and durability. A notched slot at the first end of the tag body allows for secure attachment and easy removal, even when gloves are worn. The notched slot, which may be keyhole-shaped or another suitable shape, ensures the tag remains securely looped around plant parts.

Each tag body includes at least one line of perforations, located in the middle or at the second end, to facilitate easy removal by tearing. Direction indicators, such as arrows, guide users on where to tear for clean removal, enabling the tag to unravel without cutting or damaging the plant.

A color-coding system enhances plant identification and care management. Different colors represent various plant categories, while UV-resistant pigments prevent fading from sun exposure. The tag body also features a customizable surface for labeling plant species, care instructions, or planting dates with permanent markers or adhesive labels.

Additional features include an embedded QR code that links to digital resources, such as plant care guides, growth patterns, supplier information, or interactive databases. These digital features facilitate efficient plant care and management.

Accordingly, the tree and shrub identification tag device offers a practical and effective solution for identifying plants while addressing issues associated with traditional tags. The perforated section allows for easy removal without harming branches. The availability of various colors and sizes supports different tagging needs, enhancing the overall process of plant identification and management while protecting plant health. This design effectively overcomes the limitations of existing plant identification tags.

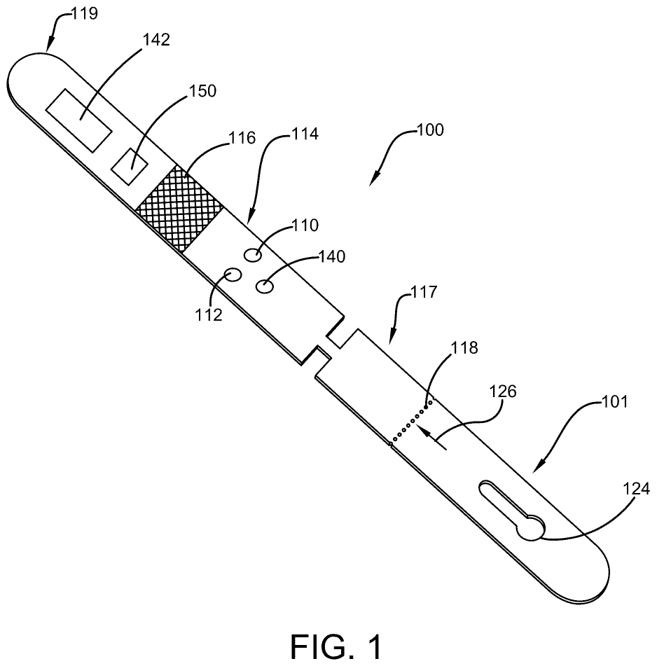

Referring initially to the drawings, FIG. 1 illustrates a perspective view of one potential embodiment of a tree and shrub identification tag device 100 of the present invention while not attached around a piece of vegetation in accordance with the disclosed architecture. The tree and shrub identification tag device 100 is designed to provide an efficient, durable, and adaptable solution for identifying various types of plants, including trees, shrubs, flowers, and saplings. The primary purpose of the device 100 is to facilitate accurate plant identification and care management while ensuring flexibility in size, ease of use, and environmental sustainability.

The device 100 is comprised of eco-friendly materials that are designed to withstand outdoor conditions. These materials include, but are not limited to, biodegradable plastics, which naturally degrade without harming the environment and eliminate the need to pick up the device 100 once discarded, and recyclable plastics, such as HDPE (High-Density Polyethylene) or PP (Polypropylene), ensuring durability, flexibility, and recyclability. The device 100 incorporates weather resistance features, including UV protection via an additive 110 such as, but not limited to, a UV stabilizer, an antioxidant, or a plasticizer to prevent fading and brittleness caused by sun exposure. Additionally, a waterproof coating 112 ensures the device 100 remains intact and legible despite exposure to rain, humidity, or irrigation systems.

The device 100 is comprised of at least one tag body 114. In different embodiments, the tag body 114 may be available in a plurality of sizes to accommodate various plants, such as flowers, shrubs, saplings, vegetation, and trees. In one embodiment, the tag body 114 is comprised of a rubberized texture 116 that further enhances grip and durability when the tag body 114 is used.

A first end 101 of the tag body 114 is further comprised of a notched slot 124 configuration optimized for easy attachment and removal, even when the user is wearing gloves. More specifically, the slot 124 allows the tag body 114 to be looped around a portion of a piece of vegetation and then threaded through the slot 124, ensuring a secure fit around a branch or other part of a plant. The shape of the notched slot 124 prevents the remainder of the tag body 114 from slipping back out of the slot 124 and unraveling from around the vegetation. The slot 124 is preferably a keyhole-shaped notch, but it may be any shape such as, but not limited to, a circular, triangular, or rectangular notch.

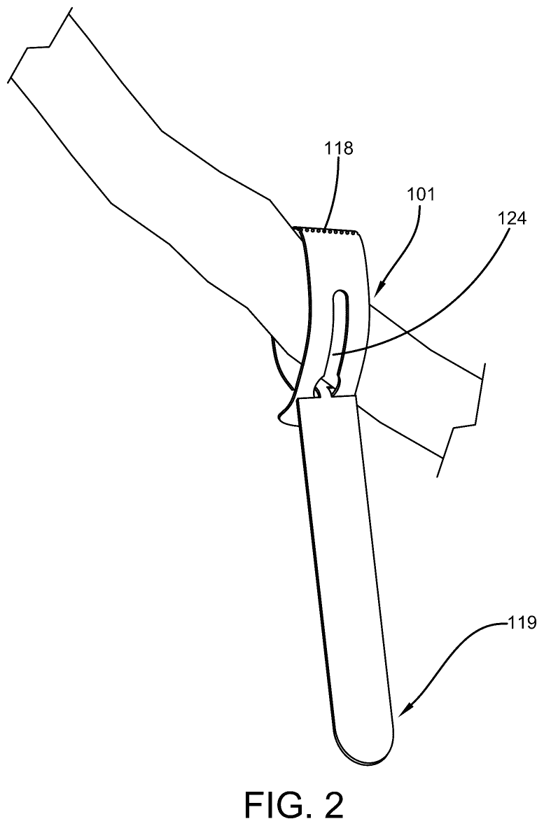

Each tag body 114 is comprised of at least one line of perforations 118 along the width of the tag body 114. The perforations 118 are preferably positioned in the middle 117 or at the second end 119 of the tag body 114. These evenly spaced perforations 118 allow users to tear off the tag body 114 once the device 100 is no longer needed. The perforations 118 are preferably positioned (as seen in FIG. 2) so that the tag body 114 can be torn, thus allowing the portion of the tag body 114 that was fed through the notched slot 124 to slip backwards through the slot 124 and unravel, allowing for easy removal. This feature enables the device 100 to fall off the vegetation without requiring cutting or other methods that could damage the plant. In one embodiment, direction indicators 126, such as arrows or directional markers, guide users on where to tear the perforations 118 for accurate and clean removal.

The device 100 also features a color-coding system 130 for efficient plant identification and care management. Each tag body 114 may be color-coded to represent different plant categories. For example, a first color may represent flowering plants, a second color may represent trees, a third color may represent shade-tolerant plants, and a fourth color may represent sun-loving plants. To maintain visibility and durability, each tag body 114 may incorporate UV-resistant pigments 140 to prevent fading during prolonged sun exposure.

Additionally, each tag body 114 includes a customizable writing surface 142 that supports clear labeling with permanent markers or adhesive labels. This customizable surface 142 allows users to record detailed information such as plant species, care instructions, or planting dates. The customizable surface 142 may be made of a matte or textured material to facilitate legibility and ease of writing.

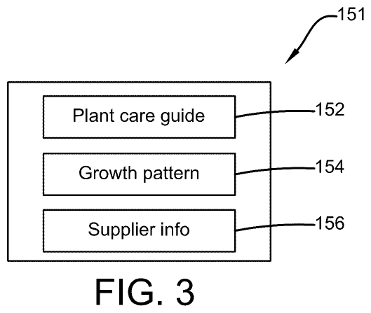

The device 100 supports additional features to enhance functionality and user experience. For example, a QR code 150 embedded on each tag body 114 provides digital information access. This QR code 150 can link users to a secondary digital location 151 (as seen in FIG. 3) on the smart device used to scan the code 150. This secondary location may include, but is not limited to, a plant care guide 152, a growth pattern informational document 154, a supplier information 156, or an interactive database 158. These digital features allow users to access detailed information quickly and efficiently, supporting comprehensive plant care and management.

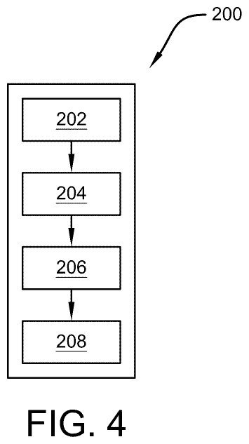

The present invention is also comprised of a method of using 200 the device 100, as seen in FIG. 4. First, a device 100 is provided, comprising a tag body 114, a notched slot 124, a customizable surface 142, at least one perforation 118, and a QR code 150 [Step 202]. Then, the tag body 114 is looped around a portion of a plant, such as a branch or stem, wherein the first end 101 of the body 114 is threaded through the notched slot 124 to secure the tag body 114 in place [Step 204]. Next, the customizable surface 142 is used to record relevant plant information, such as plant species, care instructions, or planting dates, using a permanent marker or adhesive label [Step 206]. Finally, if applicable, the QR code 150 on the tag body 114 is scanned using a smart device to access a secondary digital location 151 that may include plant care guides 152, growth patterns 154, supplier information 156, or interactive databases 158 [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “tree and shrub identification tag device” and “device” are interchangeable and refer to the tree and shrub identification tag device 100 of the present invention.

Notwithstanding the foregoing, the tree and shrub identification tag device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the tree and shrub identification tag device 100 as shown in the FIGS. are for illustrative purposes only, and that many other sizes and shapes of the tree and shrub identification tag device 100 are well within the scope of the present disclosure. Although the dimensions of the tree and shrub identification tag device 100 are important design parameters for user convenience, the tree and shrub identification tag device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tree and shrub identification tag device comprising:
a tag body having a first end and a second end;
a notched slot disposed at the first end of the tag body, wherein the notched slot is configured to secure the tag body in place by allowing the tag body to be looped and threaded through the notched slot;
a line of perforations along a width of the tag body, wherein the line of perforations facilitates tearing of the tag body for removal; and
a customizable writing surface disposed on the tag body.

2. The tree and shrub identification tag device of claim 1, wherein the notched slot is keyhole-shaped.

3. The tree and shrub identification tag device of claim 1, wherein the notched slot is circular, triangular, or rectangular.

4. The tree and shrub identification tag device of claim 1, wherein the tag body is comprised of a rubberized texture.

5. The tree and shrub identification tag device of claim 1, wherein the tag body is comprised of a direction indicator to guide tearing along the line of perforations.

6. The tree and shrub identification tag device of claim 1, wherein the tag body is comprised of a UV-resistant pigment.

7. The tree and shrub identification tag device of claim 1, wherein the tag body is comprised of a waterproof coating.

8. The tree and shrub identification tag device of claim 1, wherein the tag body is comprised of a QR code.

9. The tree and shrub identification tag device of claim 8, wherein the QR code provides access to a digital location.

10. The tree and shrub identification tag device of claim 9, wherein the digital location contains a plant-related information.

11. The tree and shrub identification tag device of claim 1, wherein the tag body is comprised of a biodegradable plastic.

12. A tree and shrub identification tag device comprising:
a color-coded tag body having a first end and a second end;
a notched slot disposed at the first end of the color-coded tag body, wherein the notched slot is configured to secure the color-coded tag body in place by allowing the color-coded tag body to be looped and threaded through the notched slot;
a line of perforations along a width of the color-coded tag body, wherein the line of perforations facilitates tearing of the color-coded tag body for removal; and
a customizable writing surface disposed on the color-coded tag body.

13. The tree and shrub identification tag device of claim 12, wherein a color of the color-coded tag represents a plant category.

14. The tree and shrub identification tag device of claim 13, wherein the plant category is comprised of a flowering plant, a shade-tolerant plant, a tree, or a sun-loving plant.

15. The tree and shrub identification tag device of claim 12, wherein the tag body is comprised of a QR code.

16. The tree and shrub identification tag device of claim 15, wherein the QR code provides access to a digital location.

17. The tree and shrub identification tag device of claim 16, wherein the digital location contains a plant-related information.

18. The tree and shrub identification tag device of claim 12, wherein the notched slot is disposed at the first end.

19. The tree and shrub identification tag device of claim 12, wherein the color-coded tag body is comprised of a biodegradable plastic.

20. A method of identifying a tree, shrub or a plant, the method comprising the following steps:
a providing a tree and shrub identification tag device comprised of a tag body having a first end, a second end, a notched slot at the first end, a customizable writing surface, a line of perforations, and a QR code;
looping the tag body around a portion of a vegetation and threading the first end through the notched slot to secure the tag body in place around the vegetation;
recording a plant information on the customizable writing surface; and
scanning the QR code with a smart device to access a digital location containing a plant-related information.
